(19) United States
(12) Patent Application Publication
(10) Pub. No.: US 2006/0203975 A1
(43) Pub. Date: Sep. 14, 2006

(54) Dynamic content stream delivery to a telecommunications terminal based on the state of the terminal's transducers

(75) Inventors: George William Erhart, Loveland, CO (US); Valentine C. Matula, Granville, OH (US); David Joseph Skiba, Golden, CO (US)

Correspondence Address: DEMONT & BREYER, LLC, SUITE 250, 100 COMMONS WAY, HOLMDEL, NJ, 07733, US

(73) Assignee: Avaya Technology Corp., Basking Ridge, NJ (US)

(21) Appl. No.: 11/240,092

(22) Filed: Sep. 30, 2005

Related U.S. Application Data
(60) Provisional application No. 60/660,249, filed on Mar. 10, 2005.

(51) Int. Cl. H04M 1/64

(52) U.S. Cl. 379/88.01

(57) ABSTRACT

Apparatus and methods are disclosed that enable an interactive voice response (IVR) system to deliver content streams of various media types (e.g., video, audio, etc.) to telecommunications terminals via the addition of extensions to the Voice extensible Markup Language (VXML). The IVR system will deliver a particular content stream to a terminal only if: (i) the terminal has a transducer (e.g., speaker, video display, etc.) that is capable of outputting the content stream's media type, and (ii) that transducer is currently enabled.

### CROSS-REFERENCE TO RELATED APPLICATIONS

This application claims the benefit of U.S. provisional application Serial No. 60/660,249, filed Mar. 10, 2005, entitled “System and Method for Multimodal Content Delivery in Interactive Response Systems,” (Attorney Docket: 630-126us), which is also incorporated by reference.

### FIELD OF THE INVENTION

The present invention relates to telecommunications in general, and, more particularly, to the delivery of one or more content streams to a telecommunications terminal based on the state of the terminal's transducers.

### BACKGROUND OF THE INVENTION

Many enterprises employ an interactive voice response (IVR) system that handles calls from telecommunications terminals. An interactive voice response system typically presents a hierarchy of menus to the caller, and prompts the caller for input to navigate the menus and to supply information to the IVR system. For example, a caller might touch the “3” key of his terminal's keypad, or say the word “three”, to choose the third option in a menu. Similarly, a caller might specify his bank account number to the interactive voice response system by inputting the digits via the keypad, or by saying the digits. In many interactive voice response systems the caller can connect to a person in the enterprise by either selecting an appropriate menu option, or by entering the telephone extension associated with that person.

FIG. 1 depicts telecommunications system 100 in accordance with the prior art. Telecommunications system 100 comprises telecommunications terminal 101, telecommunications network 105, private branch exchange (PBX) 110, and interactive voice response system 120, interconnected as shown.

Telecommunications terminal 101 is one of a telephone, a notebook computer, a personal digital assistant (PDA), etc. and is capable of placing and receiving calls via telecommunications network 105.

Telecommunications network 105 is a network such as the Public Switched Telephone Network [PSTN], the Internet, etc. that carries calls to and from telecommunications terminal 101, private branch exchange 110, and other devices not show in FIG. 1. A call might be a conventional voice telephony call, a text-based instant messaging (IM) session, a Voice over Internet Protocol (VoIP) call, etc.

Private branch exchange (PBX) 110 receives incoming calls from telecommunications network 105 and directs the calls to interactive voice response system 120 or to one of a plurality of telecommunications terminals within the enterprise, depending on how private branch exchange 110 is programmed or configured. For example, in an enterprise call center, private branch exchange 110 might comprise logic for routing calls to service agents' terminals based on criteria such as how busy various service agents have been in a recent time interval, the telephone number called, and so forth. In addition, private branch exchange 110 might be programmed or configured so that an incoming call is initially routed to interactive voice response system 120, and, based on caller input to IVR system 120, subsequently redirected back to PBX 110 for routing to an appropriate telecommunications terminal within the enterprise. Private branch exchange (PBX) 110 also receives outbound signals from telecommunications terminals within the enterprise and from interactive voice response system 120, and transmits the signals on to telecommunications network 105 for delivery to a caller's terminal.

Interactive voice response system 120 is a data-processing system that presents one or more menus to a caller and receives caller input (e.g., speech signals, keypad input, etc.), as described above, via private branch exchange 110. Interactive voice response system 120 is typically programmable and performs its tasks by executing one or more instances of an IVR system application. An IVR system application typically comprises one or more scripts that specify what speech is generated by interactive voice response system 120, what input to collect from the caller, and what actions to take in response to caller input. For example, an IVR system application might comprise a top-level script that presents a main menu to the caller, and additional scripts that correspond to each of the menu options (e.g., a script for reviewing bank account balances, a script for making a transfer of funds between accounts, etc.).

A popular language for such scripts is the Voice eXtensible Markup Language (abbreviated VoiceXML or VXML). The Voice extensible Markup Language is an application of the extensible Markup Language, abbreviated XML, which enables the creation of customized tags for defining, transmitting, validating, and interpretation of data between two applications, organizations, etc. The Voice extensible Markup Language enables dialogs that feature synthesized speech, digitized audio, recognition of spoken and keyed input, recording of spoken input, and telephony. A primary objective of VXML is to bring the advantages of web-based development and content delivery to interactive voice response system applications.

FIG. 2 depicts an exemplary Voice extensible Markup Language (VXML) script (also known as a VXML document or page), in accordance with the prior art. The VXML script, when executed by interactive voice response system 120, presents a menu with three options; the first option is for transferring the call to the sales department, the second option is for transferring the call to the marketing department, and the third option is for transferring the call to the customer support department. Audio content (in particular, synthesized speech) that corresponds to text between the <prompt> and </prompt> tags is generated by interactive voice response system 120 and transmitted to the caller.

### SUMMARY OF THE INVENTION

As video displays become ubiquitous in telecommunications terminals, it can be advantageous to deliver video content to a telecommunications terminal during a call with an interactive voice response (IVR) system, in addition to audio content. For example, a user of a telecommunications terminal who is ordering apparel via an interactive voice response system might receive a video content stream related to a particular item (e.g., depicting a model who is wearing the item, depicting the different available colors for the item, etc.). Furthermore, in some instances it might be desirable to deliver an audio content stream (e.g., music, news, etc.) to the user, perhaps during silent periods in the call, or perhaps as background audio throughout the entire call.

The illustrative embodiment of the present invention enables an interactive voice response system to deliver content streams of various media types (e.g., video, audio, etc.) to telecommunications terminals via the addition of extensions to the Voice extensible Markup Language (VXML) standard. In accordance with the illustrative embodiment, an interactive voice response system will deliver a particular content stream to a terminal only if: (i) the terminal has a transducer (e.g., speaker, video display, etc.) that is capable of outputting the content stream's media type, and (ii) that transducer is currently enabled. For example, if an IVR system script contains a command to deliver a video content stream to a telecommunications terminal during a call, but the terminal's video display has been disabled (e.g., turned off to conserve battery power, etc.), the interactive voice response system will not deliver the video content stream. Similarly, if a telecommunications terminal's speaker has been disabled (e.g., the volume has been muted, etc.), an audio content stream will not be delivered to the terminal. As another example, if an IVR system script has a command to deliver both audio and video content to a telecommunications terminal, and the terminal's speaker is enabled but its video display is disabled, the interactive voice response system will deliver only the video content.

In the illustrative embodiment, the interactive voice response system also monitors changes in the enabled/disabled status of the calling terminal's transducers during the call. If, while a content stream is being delivered to a terminal, the associated transducer (i.e., the transducer whose media type matches that of the content stream) changes state from enabled to disabled, the IVR system stops transmitting the content stream. If the associated transducer subsequently changes state back to enabled from disabled during the call, the interactive voice response system either resumes transmission of the stopped content stream (i.e., begins transmitting the stream at the point at which playback was stopped) or re-starts transmission of the stopped content stream from the beginning, where resuming versus re-starting might be based on an implementation choice, a system administrator's preferences, a caller's preferences, the nature of a particular content stream (e.g., real-time versus pre-recorded, etc.), and so forth.

The illustrative embodiment comprises: transmitting a signal of media type T to a telecommunications terminal during a call only when (i) the telecommunications terminal has a transducer whose output is of the media type T, and (ii) the transducer is enabled.

### BRIEF DESCRIPTION OF THE DRAWINGS

FIG. 1 depicts telecommunications system 100 in accordance with the prior art.

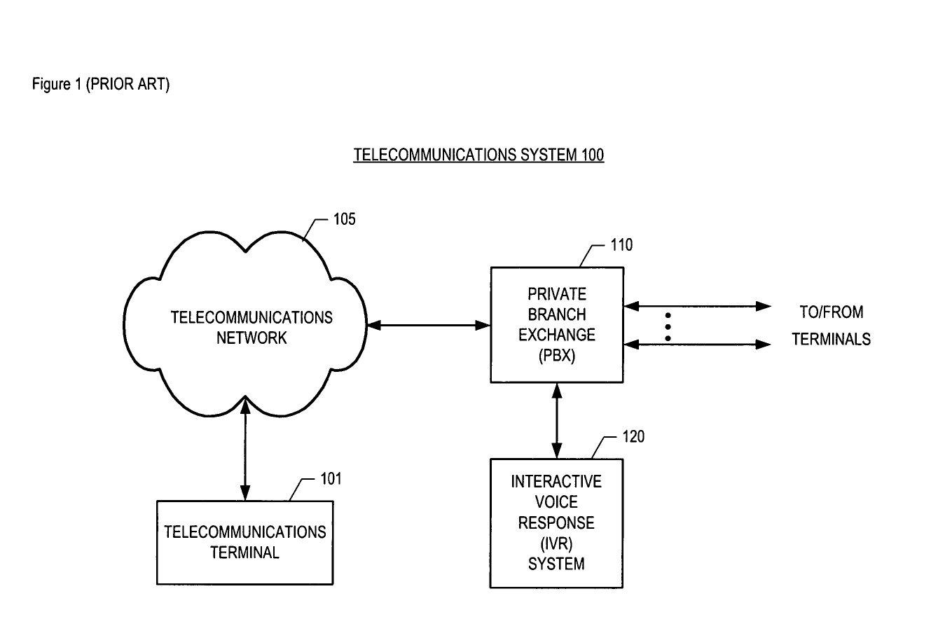

FIG. 2 depicts an exemplary Voice extensible Markup Language (VXML) script, in accordance with the prior art.

FIG. 3 depicts telecommunications system 300 in accordance with the illustrative embodiment of the present invention.

FIG. 4 depicts an exemplary Voice extensible Markup Language (VXML) script, in accordance with the illustrative embodiment of the present invention.

FIG. 5 depicts a flowchart of the salient tasks of interactive voice response system 320, as shown in FIG. 3, in accordance with the illustrative embodiment of the present invention.

FIG. 6 depicts a flowchart of the salient tasks of a thread that is spawned at task 560 of FIG. 5, in accordance with the illustrative embodiment of the present invention.

FIG. 7 depicts a flowchart of the salient tasks of telecommunications 301, as shown in FIG. 3, during a call with interactive voice response system 320, in accordance with the illustrative embodiment of the present invention.

### DETAILED DESCRIPTION

The terms appearing below are given the following definitions for use in this Description and the appended Claims.

For the purposes of the specification and claims, the term “call” is defined as an interactive communication involving one or more telecommunications terminal users. A call might be a traditional voice telephone call, an instant messaging (IM) session, a video conference, etc.

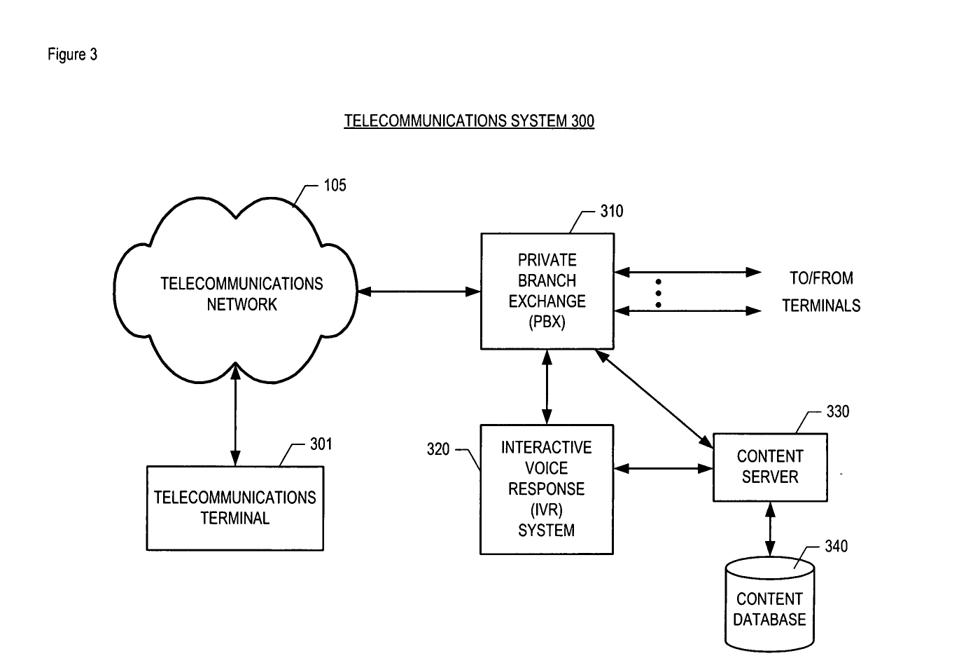

FIG. 3 depicts telecommunications system 300 in accordance with the illustrative embodiment of the present invention. Telecommunications system 300 comprises telecommunications terminal 301, telecommunications network 105, private branch exchange (PBX) 310, interactive voice response system 320, content server 330, and content database 340, interconnected as shown.

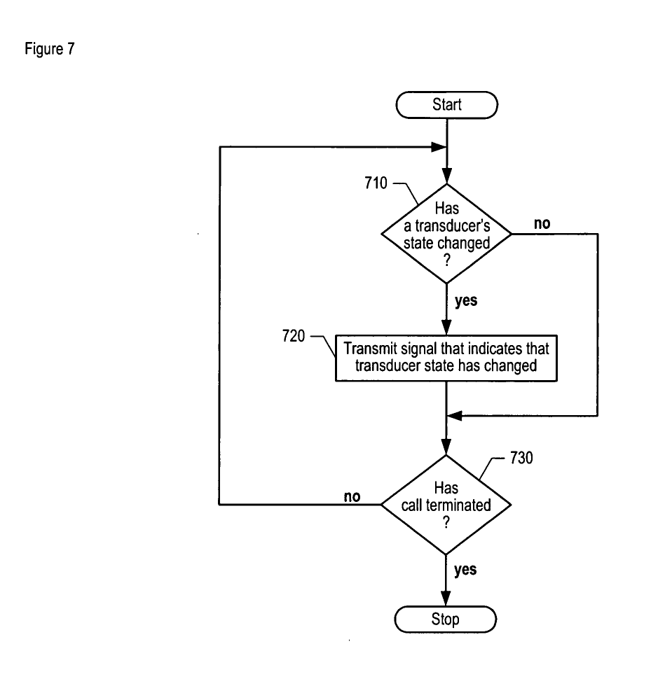

Telecommunications terminal 301 is one of a telephone, a notebook computer, a personal digital assistant (PDA), etc. and is capable of placing and receiving calls via telecommunications network 305. Telecommunications terminal 301 has one or more transducers (e.g., a speaker, a video display, etc.) that can be enabled and disabled by the user, or by telecommunications terminal 301 itself, or both. A transducer is disabled if it has been “turned off,” or if its output has been suppressed (e.g., speaker volume muted, brightness set to zero, etc.). In addition, telecommunications terminal 301 is capable of performing the method of FIG. 7, described below.

Private branch exchange (PBX) 310 provides all the functionality of private branch exchange (PBX) 110 of the prior art, and is also capable of receiving streamed content (e.g., audio, video, multimedia, etc.) from content server 330, of forwarding streamed content on to telecommunications network 105 for delivery to a caller's terminal, and of transmitting signals related to streamed content to content server 330. Furthermore, in addition to conventional telephony-based signaling and voice signals, private branch exchange 310 is also capable of transmitting and receiving Internet Protocol (IP) data packets, Session Initiation Protocol (SIP) messages, Voice over IP (VoIP) traffic, and stream-related messages (e.g., Real Time Streaming Protocol [RTSP] messages, etc.) to and from interactive voice response system 320. It will be clear to those skilled in the art, after reading this specification, how to make and use private branch exchange (PBX) 310.

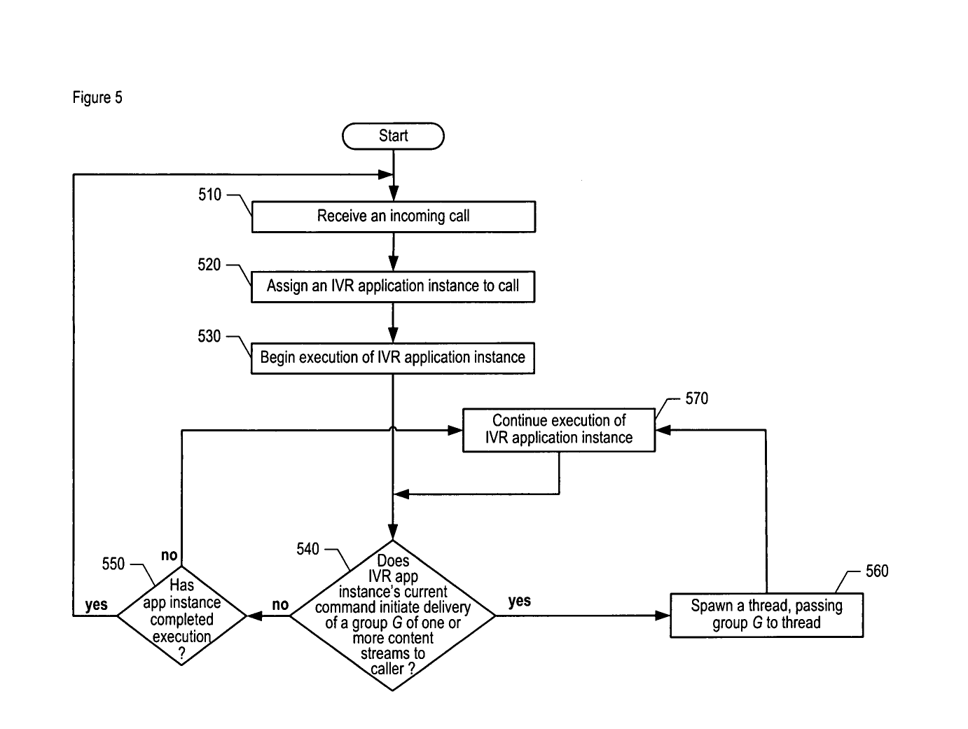

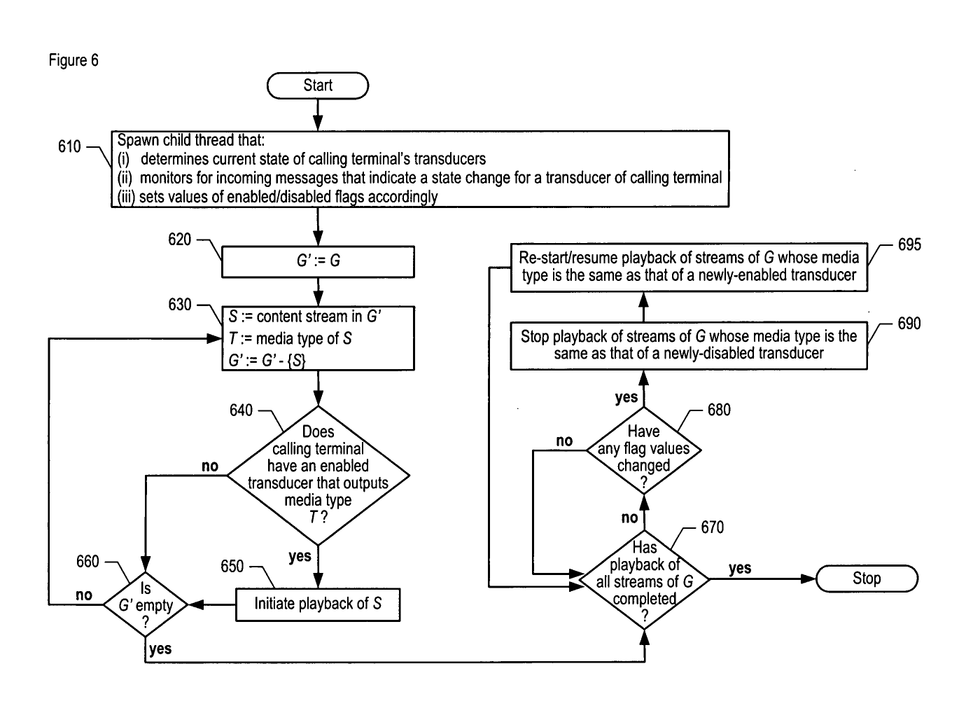

Interactive voice response system 320 provides all the functionality of interactive voice response system 120 of the prior art, and is also capable of: transmitting commands to content server 330 (e.g., starting playback of a content stream, stopping playback of the content stream, queueing another content stream, etc.); receiving information from content server 330 (e.g., an indication that playback of a content stream has begun, an indication that playback of a content stream has completed, etc.); and executing the tasks described below and with respect to FIGS. 5 and 6. It will be clear to those skilled in the art, after reading this specification, how to make and use interactive voice response system 320.

Content server 330 is capable of retrieving content from content database 340, of buffering and delivering a content stream to a calling terminal via private branch exchange 310, of receiving commands from interactive voice response system 320 (e.g., to start playback of a content stream, to queue another content stream, etc.), of transmitting status information to interactive voice response system 310, and of generating content (e.g., dynamically generating a video of rendered text, etc.) in well-known fashion. It will be clear to those skilled in the art, after reading this specification, how to make and use content server 330.

Content database 340 is capable of storing a plurality of multimedia content (e.g., video content, audio content, etc.) and of retrieving content in response to commands from content server 330, in well-known fashion. It will be clear to those skilled in the art, after reading this specification, how to make and use content database 340.

As will be appreciated by those skilled in the art, some embodiments of the present invention might employ an architecture for telecommunications system 300 that is different than that of the illustrative embodiment (e.g., IVR system 320 and content server 330 might reside on a common server, etc.). It will be clear to those skilled in the art, after reading this specification, how to make and use such alternative architectures.

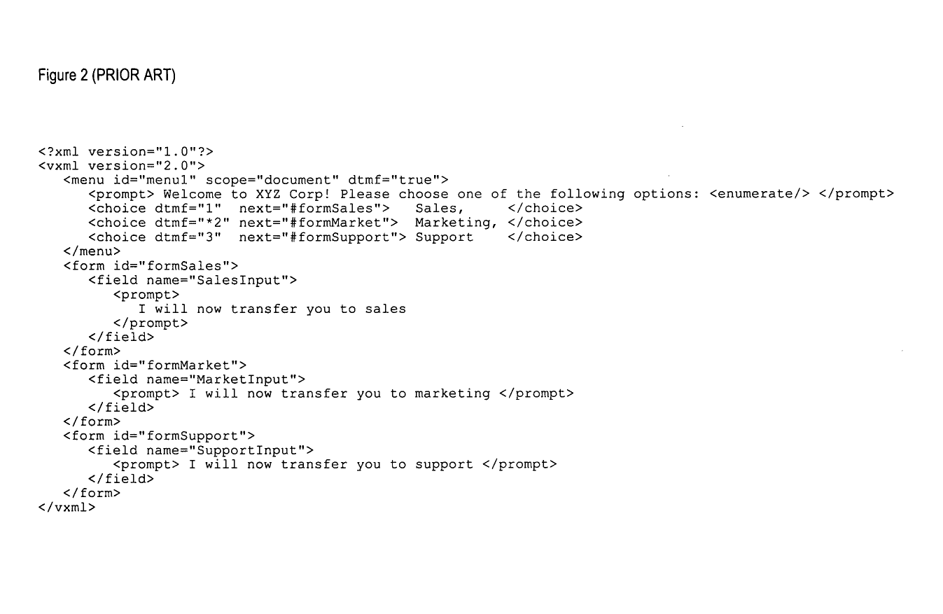

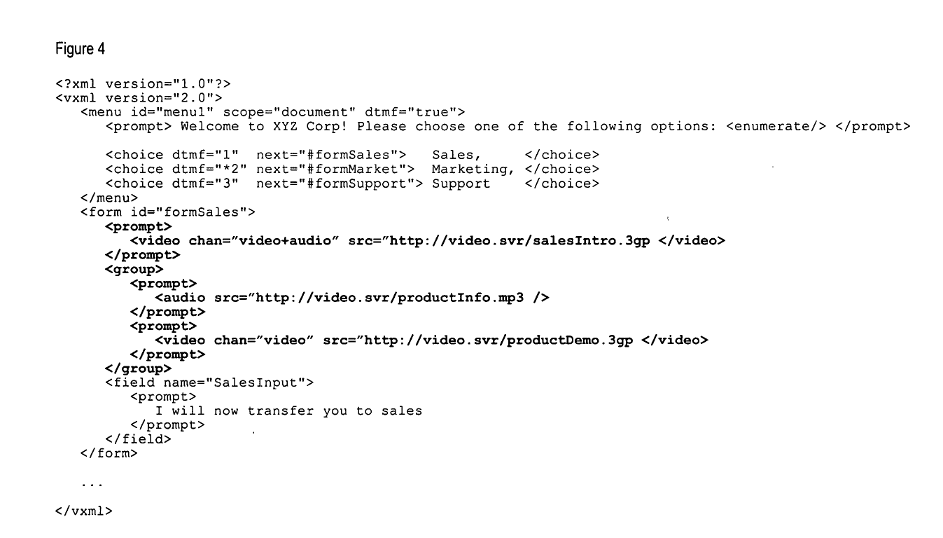

FIG. 4 depicts an exemplary Voice Extensible Markup Language (VXML) script, in accordance with the illustrative embodiment of the present invention. The script is the same as the script of FIG. 2 of the prior art, with the addition of lines of code depicted in boldface. As shown in FIG. 4, the script now contains prompts that are audio and video content streams, in addition to speech prompts. In particular, in accordance with the illustrative embodiment, when the user selects choice 1 (sales), interactive voice response system 320 will deliver concurrently the audio and video streams in file “salesIntro.3gp” if the calling terminal has both an enabled speaker and an enabled video display. If, instead, the calling terminal has an enabled speaker and either (i) no video display or (ii) a disabled video display, then interactive voice response system 320 will deliver the audio stream portion of “salesIntro.3gp” only. Similarly, if the calling terminal has an enabled video display and either (i) no speaker or (ii) a disabled speaker, then interactive voice response system 320 will deliver the video stream portion of “salesIntro.3gp” only.

As shown in FIG. 4, in accordance with the illustrative embodiment, a VXML script can also have a <group> block that comprises a plurality of content streams, where each of the streams has a different media type. Interactive voice response system 320 will deliver concurrently all of the streams in the <group> block for which the calling terminal has a corresponding enabled transducer. For example, in the script of FIG. 4, after playback of “salesIntro.3gp” has completed, interactive voice response system 320 will deliver one, both, or neither of “productInfo.3gp” and “productDemo.3gp” in accordance with whether the calling terminal has a speaker that is enabled, and a video display that is enabled. As will be appreciated by those skilled in the art, in some other embodiments of the present invention, a tag or programming language construct other than a <group> block might be employed to organize multiple content streams.

FIG. 5 depicts a flowchart of the salient tasks of interactive voice response system 320, as shown in FIG. 3, in accordance with the illustrative embodiment of the present invention. It will be clear to those skilled in the art which tasks depicted in FIG. 5 can be performed simultaneously or in a different order than that depicted.

At task 510, an incoming call is received at interactive voice response system 320, in well-known fashion.

At task 520, interactive voice response system 320 assigns an instance of an appropriate IVR system application to the incoming call, in well-known fashion. As will be appreciated by those skilled in the art, although in the illustrative embodiments an instance of an IVR system application handles one incoming call at a time, in some other embodiments of the present invention an application instance might handle a plurality of calls concurrently.

At task 530, interactive voice response system 320 begins executing the IVR application instance, in well-known fashion.

At task 540, interactive voice response system 320 checks whether the current command to be executed in the IVR application instance initiates delivery of a group G of one or more content streams to the calling telecommunications terminal. (A group might be specified explicitly by a <group> block, or implicitly via a single prompt [e.g., the audio and video streams of a 3gp file, etc.]). If so, execution continues at task 560, otherwise, execution proceeds to task 550.

At task 550, interactive voice response system 320 checks whether the IVR application instance's execution has completed. If so, execution continues back at task 510 for the next incoming call; otherwise, execution proceeds to task 590.

At task 560, interactive voice response system 320 spawns a thread, passing group G to the thread. As will be appreciated by those skilled in the art, data can be passed to threads in a variety of ways, such as via a memory pointer, via an operating system inter-thread communication mechanism, and so forth. The operation of the thread is described in detail below and with respect to FIG. 6.

At task 570, interactive voice response system 320 continues the execution of the IVR application instance, in well-known fashion. After task 570, execution continues back at task 540.

FIG. 6 depicts a flowchart of the salient tasks of a thread that is spawned at task 560 of FIG. 5, in accordance with the illustrative embodiment of the present invention. It will be clear to those skilled in the art which tasks depicted in FIG. 6 can be performed simultaneously or in a different order than that depicted.

At task 610, the thread spawns a child thread that: (i) determines the existence and current state of transducers of the calling terminal; (ii) monitors during the call for incoming messages that indicate a state change for a transducer of the calling terminal; and (iii) accordingly sets the values of enabled/disabled flags that correspond to the media types of group G. The child thread performs subtask (iii) after performing subtask (i) at startup, and subsequently during the call whenever the monitoring of subtask (ii) indicates that a transducer has changed state. The child thread dies when the (parent) thread dies (i.e., after the determination of task 670, described below, is affirmative).

At task 620, the thread copies the contents of group G into variable G′.

At task 630, the thread sets variable S to one of the content streams of G′, sets variable T to the media type of content stream S, and removes S from G′.

At task 640, the thread checks whether the enabled/disabled flag for media type T indicates that the calling terminal has an enabled transducer that outputs media type T. If so, execution proceeds to task 650, otherwise execution continues at task 660.

At task 650, the thread issues a command to content server 330 to initiate playback of content stream S, in well-known fashion.

At task 660, the thread checks whether G′ is empty. If not execution continues back at task 630, otherwise execution proceeds to task 670.

At task 670, the thread checks whether playback has completed for all content streams of G. If so, the thread and its child die, otherwise execution continues at task 680.

At task 680, the thread checks whether any of the enabled/disabled flags have changed. If not, execution continues back at task 670, otherwise execution proceeds to task 690.

At task 690, the thread stops playback of any streams of G whose media type is the same as that of a newly-disabled transducer. In other words, when a flag changes from enabled to disabled, the stream whose media type is associated with that flag is stopped.

At task 695, the thread resumes (or re-starts, as appropriate) playback of any streams of G whose media type is the same as that of a newly-enabled transducer. In other words, when a flag changes from disabled to enabled, the stream whose media type is associated with that flag is resumed/re-started.

After task 695, execution of the thread continues back at task 670.

FIG. 7 depicts a flowchart of the salient tasks of telecommunications 301 during a call with interactive voice response system 320, in accordance with the illustrative embodiment of the present invention.

At task 710, telecommunications terminal 301 checks whether any of its transducers has changed state from enabled to disabled, or from disabled to enabled. If so, execution proceeds to task 720, otherwise execution continues at task 730.

At task 720, telecommunications terminal 301 transmits a signal to interactive voice response system 320 that indicates the change in state of the transducer. In the illustrative embodiment this signal is transmitted as a Session Initiation Protocol (SIP) message. It will be clear to those skilled in the art how to send a signal that carries the state-change information via some other method or protocol.

At task 730, telecommunications terminal 301 checks whether the call has terminated. If so, the method of FIG. 7 terminates, otherwise execution continues back at task 710.

As will be appreciated by those skilled in the art, in some embodiments of the present invention it might be advantageous for telecommunications network 105 to be aware of transducer state changes at telecommunications terminal 301 when the terminal is not involved in a call with interactive voice response system 320 (e.g., during a call with another terminal, between calls, etc.) Such embodiments could enable other applications that are independent of interactive voice response system 320 to make use of this information. As will be appreciated by those skilled in the art, in such embodiments the method of FIG. 7 should be modified so that it executes at times other than just during calls with interactive voice response system 320. As will be further appreciated by those skilled in the art, in such embodiments one or more terminals or elements of telecommunications network 105's infrastructure (e.g., a switch, etc.) might be reprogrammed to monitor for transducer state-change signals at terminal 301 and maintain appropriate flags, as is done by the child thread spawned by task 610 at interactive voice response system 320.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising transmitting a signal of media type T to a telecommunications terminal during a call only when:
(i) said telecommunications terminal has a transducer whose output is of said media type T, and
(ii) said transducer is enabled.

2. The method of claim 2 wherein said telecommunications terminal enables its user to enable and disable said transducer during said call.

3. The method of claim 1 wherein the transmitting of said signal is effected by an interactive voice response system that is involved in said call.

4. A method comprising stopping the transmission of a signal of media type T to a telecommunications terminal during a call that involves said telecommunications terminal when a transducer of said telecommunications terminal whose output is of said media type T changes state from enabled to disabled during said call.

5. The method of claim 4 further comprising re-starting the transmission of said signal when said transducer changes state back to enabled during said call.

6. The method of claim 4 further comprising resuming the transmission of said signal when said transducer changes state back to enabled during said call.

7. The method of claim 4 wherein said telecommunications terminal enables its user to enable and disable said transducer during said call.

8. The method of claim 4 wherein the stopping of the transmission of said signal is effected by an interactive voice response system that is involved in said call.

9. A method comprising transmitting a first signal from a telecommunications terminal when a transducer of said telecommunications terminal whose output is of media type T changes state from enabled to disabled, wherein said first signal is for notifying at least one of:
(i) a network infrastructure element,
(ii) another telecommunications terminal, and
(iii) an interactive voice response system that signals of said media type Tare unwelcome at said telecommunications terminal.

10. The method of claim 9 wherein said transducer changes state from enabled to disabled during a call that involves said telecommunications terminal, and wherein the transmitting of said first signal occurs during said call.

11. The method of claim 10 wherein said telecommunications terminal is receiving a second signal of said media type T when said transducer changes state from enabled to disabled.

12. A method comprising setting a flag when a transducer of a telecommunications terminal whose output is of media type T changes state from enabled to disabled, wherein said flag indicates that signals of said media type T are unwelcome at said telecommunications terminal.

13. The method of claim 12 further comprising refusing, after the setting of said flag, to accept at said telecommunications terminal a signal of said media type T.

14. A method comprising transmitting a first signal from a telecommunications terminal when a transducer of said telecommunications terminal whose output is of said media type T changes state from disabled to enabled, wherein said first signal is for notifying at least one of:
(i) a network infrastructure element,
(ii) another telecommunications terminal, and
(iii) an interactive voice response system
that signals of said media type T are now welcome at said telecommunications terminal.

15. The method of claim 14 wherein said transducer changes state from disabled to enabled during a call that involves said telecommunications terminal.

16. The method of claim 15 wherein said call also involves said interactive voice response system, and wherein said first signal is also for notifying said interactive voice response system to re-start the transmission of a second signal of said media type T to said telecommunications terminal.

17. The method of claim 15 wherein said call also involves said interactive voice response system, and wherein said first signal is also for notifying said interactive voice response system to resume the transmission of a second signal of said media type T to said telecommunications terminal.

18. A method comprising setting a flag when a transducer of a telecommunications terminal whose output is of media type T changes state from disabled to enabled, wherein said flag indicates that signals of said media type Tare now welcome at said telecommunications terminal.

19. The method of claim 18 further comprising receiving at said telecommunications terminal a signal of said media type T after the setting of said flag.

20. A method comprising transmitting to a telecommunications terminal exactly one of:
a first signal of media type T₁ when said telecommunications terminal has a transducer that is enabled and whose output is of said media type T₁, and
a second signal of media type T₂ otherwise.

21. The method of claim 20 wherein the transmitting occurs during a call that involves said telecommunications terminal.

22. A method comprising:
transmitting to a telecommunications terminal a first signal of media type T₁ and a second signal of media type T₂; and
when a transducer of said telecommunications terminal whose output is of said media type T₁ changes state from enabled to disabled, stopping the transmission of said first signal only.

23. The method of claim 22 wherein the transmitting and the stopping is effected by an interactive voice response system during a call that involves said telecommunications terminal and said interactive voice response system.
